(19) United States
(12) Patent Application Publication
(10) Pub. No.: US 2025/0170745 A1
(43) Pub. Date: May 29, 2025

(54) GLUE FOR BOARDS

(71) Applicant: UNILIN, BV, Wielsbeke (BE)

(72) Inventor: Koen NEL, Kortrijk (BE)

(21) Appl. No.: 18/730,550

(22) PCT Filed: Jan. 24, 2023
(86) PCT No.: PCT/IB2023/050582

§ 371 Date: Jul. 19, 2024

(30) Foreign Application Priority Data
Feb. 4, 2022 (BE) 2022/5071
Sep. 1, 2022 (BE) 2022/5697

(51) Int. Cl. B27N 3/00; B27N 3/04; B27N 3/20; C09J 177/04

(52) U.S. Cl. CPC B27N 3/002; B27N 3/04; B27N 3/203; C09J 177/04

(57) ABSTRACT

A board includes cellulose-containing materials, such as plant fibres and/or wood chips and/or wood parts, and a glue which connects these cellulose-containing materials to each other. The glue is a glue based on hyperbranched polyamides. A method is provided for making such boards and a glue for such boards

The present invention relates to a board comprising cellulose-containing materials, such as plant fibres and/or wood chips and/or wood parts, and a glue which connects these cellulose-containing materials to each other.

The present invention also relates to a method for making such a board and also to a glue for such boards.

The present invention relates to boards comprising cellulose-containing materials. These cellulose-containing materials may comprise one or more of the following materials: wood fibres, wood chips, wood shavings, wood layers, wood waste from, inter alia, the recycling of, for example, chipboards/wood fibreboards, flax fibres, bamboo fibres, hemp fibres, etc. These cellulose-containing materials may thus be lignocellulose-containing materials, for example. The boards are, for example, wood fibreboards, such as MDF (Medium Density Fibreboard) and HDF (High Density Fibreboard), other wood-based boards such as chipboards, OSB (oriented strand board), multiplex boards, etc., and non-wood-based fibreboards. These boards may or may not be partially or completely formed from recycled material, such as recycled lignocellulose-containing material. The cellulose-containing materials may thus also comprise recycled materials from the recycling of, for example, chipboards, wood fibreboards or panels comprising such chipboards and wood fibreboards. Chipboards may thus comprise particles of recycled chipboards or wood fibreboards may comprise particles of recycled wood fibreboards.

The most common glue used in the production of such boards is an aminoplast polymer, produced by a polycondensation reaction from urea and formaldehyde to form a urea-formaldehyde resin (UF resin). Melamine is optionally added and a melamine-urea-formaldehyde resin (MUF resin) is obtained, or melamine and phenol are added (MUPF resins: melamine-urea-phenol-formaldehyde). The major advantages of such glues are their low cost—owing to the use of generally available and inexpensive raw materials in their preparation—; and their high reactivity. Such glues may release formaldehyde during and after polymerization under the influence of temperature or pH change. Efforts are increasingly being made to limit the release of formaldehyde from boards or even reduce it to zero. Therefore, formaldehyde-free glues have been and are being sought for the production of above-mentioned boards.

US2006/0163769 describes the use of water glass as glue in the production of derived wood products which are fire-resistant.

A known formaldehyde-free glue for use in the production of derived wood products consists of polymeric methylene diphenyl diisocyanate (pMDI).

CA2019382A1 describes a mixture of isocyanate and a sufficient amount of metal soap to be used as glue in derived wood products. The metal soap is used as a blocking compound to prevent reaction between water and isocyanate, therefore a sufficient amount of metal soap is required. CA2019382A1 further describes that when mixing isocyanate and the sufficient amount of metal soap, water glass may also be admixed to form an emulsion.

An additional disadvantage of all these above-mentioned glues is that they are based on fossil raw materials.

Bio-based glues for boards already exist, but the production of boards with the aid of these glues is more difficult. Disadvantages include too low a reactivity, rapid pre-polymerization, limited glue power and poor wetting properties, in comparison with the current aminoplast glues comprising formaldehyde. Examples of bio-based glues are glues based on lignin, plant flour such as soya, or sugars.

The present invention first and foremost proposes an alternative board comprising cellulose-containing materials and a glue and a method for forming such alternative boards, wherein, in accordance with various embodiments, solutions are offered to the problems with such boards from the prior art.

The invention relates to a board comprising cellulose-containing materials, such as plant fibres and/or wood chips and/or wood parts, and a glue which connects these cellulose-containing materials to each other, wherein the glue is a glue based on hyperbranched polyamides. These cellulose-containing materials are preferably lignocellulose-containing materials. The plant fibres are, for example, wood fibres. These wood fibres may or may not be present in the form of wood fibre bundles.

Surprisingly, it has been found that glues based on hyperbranched polyamides can be used to connect cellulose-containing materials such as plant fibres, for example wood fibres and flax fibres, wood-comprising parts, such as wood chips, wood shavings, and wood layers, and recycled wood-comprising parts, and that, in addition, this glue affords a particularly good glue power. In addition, the production of boards with the aid of this glue can be effected in a similar manner to the production of such boards using conventional urea-formaldehyde glues (UF glues). It is therefore possible to switch to a glue based on hyperbranched polyamides without needing to significantly alter the production process. These boards are obtained, for example, by providing the cellulose-containing materials with the glue and then pressing the cellulose-containing materials provided with glue to form board-like material, wherein this board-like material is, for example, sawn into boards or already forms a board having the desired dimensions. The pressing is preferably effected at an elevated temperature, these temperatures possibly rising to more than 200° C.

Even more surprisingly, it has been found that boards comprising cellulose-containing materials which are connected to each other using a glue based on hyperbranched polyamides exhibit better technical characteristics than such boards comprising conventional UF glues. It is thus possible to obtain a higher stiffness (N/mm²) and transverse tensile strength (N/mm²) and/or a higher water resistance.

A glue based on hyperbranched polyamides denotes a glue whose dry matter consists largely of hyperbranched polyamides, for example of at least 50 percent by weight of hyperbranched polyamides in relation to the total weight of the dry matter, preferably at least 70 percent by weight and even more preferably at least 80 percent by weight.

Hyperbranched polyamides are highly branched three-dimensional macromolecules. Hyperbranching/high branching indicates that the polyamides are not linear and also that there are a significant number of branches. This means that there are more than three, preferably more than five, and even more preferably more than 10, branches present in the polyamide macromolecule. Such polyamides may be bio-based. A glue comprising hyperbranched polyamides may, for example, be based on polycondensed amino acids, wherein these amino acids are produced, for example, with the aid of bacteria. To form these hyperbranched polyamides, it is possible to opt to block no or virtually no groups or positions of the amino acid. It is thus possible to opt to not block the a position and/or the & position of the amino acid. Bacteria, such as Corynebacterium (gram-positive) or Escherichia coli (gram-negative), can chemically convert amino acids in a targeted manner into, for example, predominantly lysine and a proportion of glutamine by fermentation. Such glues therefore contribute to the sustainability of said boards. In addition, this glue does not have to comprise any formaldehyde and preferably this glue comprises no formaldehyde, with the result that there are also no problems with potential release of formaldehyde. If the hyperbranched polyamides are based on polycondensed amino acids, it is not necessary for them to be based only on one type of amino acid. If use is made of bacteria which form, for example, predominantly lysine and a small proportion of other amino acids such as glutamine, both the lysine and the glutamine can be used for the production of hyperbranched polyamides, as a result of which an additional purification step of the amino acids is not necessary and these glues can be produced in an ecological manner.

An additional advantage is that boards comprising glue based on hyperbranched polyamides can be recycled again and can be used as raw material to form such boards again.

Use is preferably made of only one, first type of glues in order to form the boards, namely glues based on hyperbranched polyamides, but the boards may also comprise other types of glues. Use may thus be made of a glue mixture comprising the first type of glue and one or more other types of glues, and/or the board may be of multi-layer form, wherein the first type of glue is used in one aforementioned layer and another type of glue is used for another aforementioned layer. Examples of other glues are, for example, conventional UF glues, MUF glues, MUPF glues, pMDI glues, polyurethane glues, polyvinyl butyral glues, polyacrylate glues, etc. Polyurethane glues may for example be used to increase the water resistance and/or flexibility. It is also possible for a board to be formed using different glues from the first type of glue. The board may thus be of multi-layer form, wherein different glues, but for example glues all based on hyperbranched polyamides, are used for the different layers. These last-mentioned different glues may differ in all kinds of areas. A non-exhaustive list of possible differences follows, these differences being able to be combined with each other insofar as it is not contradictory: dry matter content, the average molecular weight of the hyperbranched polyamides, auxiliary substances such as solvents, auxiliary substances such as potassium hydroxide or sodium hydroxide, crosslinkers, catalysts, chemical composition of the polyamides, etc. The glue used to form the boards may comprise multiple components. All the components of the glue may have already been mixed in advance and stored thus. However, it is not necessary for all the components of the glue to have already been mixed and stored prior to the formation of the boards. It is possible for the components to be combined only prior to the treatment with glue and/or during the treatment with glue, for the purpose of forming the board. It is not necessary for all the components of the glue used for forming the board to be found in the board. Certain components of the glue used may have reacted with each other in such a way that they are no longer able to be (separately) identified in the board. The glue used may, for example, be of one-component form, wherein all the components have already been combined and are stored together. The glue used may also be of two-component or multi-component form. It is thus possible for the glue used to comprise a first component and a second component, wherein these two components are combined only prior to the treatment with glue of the cellulose-containing materials, or wherein these two components are added to the cellulose-containing materials separately, possibly simultaneously, in order to then produce a board comprising said glue based on hyperbranched polyamides.

In a preferred embodiment, said hyperbranched polyamides are obtained by polycondensation of amino acids, wherein these amino acids are preferably selected from the group comprising arginine, glutamine, asparagine and lysine. Here, the hyperbranched polyamides are obtained via peptide bonds, with no preference being given, for example, to functional groups of the amino acids. Preferably, no positions on the amino acids are blocked during the polycondensation. In this way, a complex network of polyamides is obtained which can readily serve as glue for cellulose-containing materials. The hyperbranched polyamides are for example obtained from the polycondensation of predominantly lysine. The hyperbranched polyamides are then, for example, hyperbranched polyamino acids comprising more than 80% by weight, preferably more than 90% by weight, of lysine. Lysine is a basic amino acid which is cationic in a neutral medium. Lysine is for example obtained by fermentation using bacteria, such as Corynebacterium or Escherichia coli bacterium. Smaller amounts of other amino acids such as glutamine may also be formed during the production of lysine. The desired amino acids can be formed by the choice of the bacteria, the nutrients and the fermentation conditions. For this fermentation, multiple carbohydrate sources may be used such as sucrose, glucose, cellulose, hemicellulose, starch or lignin. The ammonium source used for the fermentation is often mixtures of ammonium salts, such as ammonium sulfate or diammonium phosphate. Ammonium sulfate may be obtained as a secondary product during the processing of manure or after the stripping of ammonia-containing gases. In other words, amino acids, such as lysine, can be entirely or largely produced based on bio-based raw materials and/or waste materials. The hyperbranched polyamides obtained by polycondensation of amino acids may be obtained by polycondensation of one, two, three or all four of said amino acids from the group comprising arginine, glutamine, asparagine and lysine. It is also possible for the hyperbranched polyamides to be obtained by polycondensation of amino acids, which are selected from the group comprising arginine, glutamine, asparagine and lysine, and one or more other amino acids.

In a specific embodiment, the hyperbranched polyamides comprise a first group of hyperbranched polyamides having an average molecular weight of between 500 and 100 000 g/mol, preferably of between 5000 and 50 000 g/mol and even more preferably of between 10 000 and 25 000 g/mol, wherein the first group of hyperbranched polyamides preferably constitutes at least 60 percent by weight, even more preferably at least 65 percent by weight, even more preferably at least 70 percent by weight, even more preferably at least 75 percent by weight, and most preferably at least 80 percent by weight, of the hyperbranched polyamides. The reactivity of the hyperbranched polyamides is optimal if the molecular weight is higher than 5000 g/mol and the treatment with glue can be effected in a highly satisfactory manner when the molecular weight is lower than 50 000 g/mol. This therefore allows good production of the boards. The molecular weight of hyperbranched polyamides may be determined, for example, by low-angle laser light scattering (LALLS). As an alternative or in addition, the molecular weight may be determined by gel permeation chromatography (GPC).

In a preferred embodiment, the board comprises one or more layers, wherein at least one aforementioned layer comprises said cellulose-containing materials and said glue, wherein the weight ratio of hyperbranched polyamides to cellulose-containing materials in this layer is preferably between 0.03 and 0.15. With this weight ratio, the cellulose-containing materials are preferably dried cellulose-containing materials. The weight ratio is preferably a weight ratio based on the weight of dry matter. Here, it is possible for only one layer, or only a number of layers, to comprise cellulose-containing materials and said glue based on hyperbranched polyamides, whereas other layers then, for example, comprise another glue. Preferably, all of said layers comprise cellulose-containing materials and a glue based on hyperbranched polyamides. This weight ratio is calculated, for example, as the percentage of dry matter of glue in relation to dry matter of cellulose-containing materials, thus for example in relation to dry wood comprising no residual moisture.

In a specific embodiment, the board comprises three or more layers, namely two outer layers and one or more central layers, wherein at least one central layer comprises said cellulose-containing materials and said glue, and wherein the outer layers each comprise cellulose-containing materials and a glue based on hyperbranched polyamides, wherein the weight ratio of hyperbranched polyamides to cellulose-containing materials in the outer layers is higher than the weight ratio of hyperbranched polyamides to cellulose-containing materials in the last-mentioned central layer. The weight ratio is preferably a weight ratio based on the weight of dry matter. Thus, the weight ratio of hyperbranched polyamides to cellulose-containing materials in the outer layers may, for example, be between 0.06 and 0.12 and the weight ratio of hyperbranched polyamides to cellulose-containing materials in an aforementioned central layer may be between 0.03 and 0.10, preferably between 0.035 and 0.05. The glue used for the outer layers may be the same glue as the glue used for the one or more aforementioned central layers. However, it is possible for different glues to be used for the different layers, but for example still glues based on hyperbranched polyamides. The board may, for example, be a three-layer chipboard comprising two outer layers with finer wood chips and a central layer with coarser wood chips, wherein the outer layers comprise 8 percent by weight of hyperbranched polyamides in relation to dry wood chips and the central layer comprises 4.5 percent by weight of hyperbranched polyamides in relation to dry wood chips. Here, dry wood chips denotes wood chips without residual moisture. The central layer may comprise recycled wood chips. Such chipboards may be manufactured with the aid of press plates, for example, at temperatures of between 170° C. and 245° C., at a pressure of between 2 and 5 N/mm², for a duration of at least three seconds, preferably at least five seconds, per mm of board thickness. The composition of the cellulose-containing materials may be different for each layer. The one or more central layers and/or the outer layers may, for example, comprise recycled cellulose-containing materials.

In a particular embodiment, the hyperbranched polyamides comprise a first group of hyperbranched polyamides and a second group of hyperbranched polyamides, wherein the average molecular weight of the first group of hyperbranched polyamides is at least three times higher, preferably at least five times higher, than the average molecular weight of the second group of hyperbranched polyamides and/or wherein the average molecular weight of the first group of hyperbranched polyamides is at most 15 times higher, preferably at most 10 times higher, than the average molecular weight of the second group of hyperbranched polyamides. Here, the first group of hyperbranched polyamides form the high molecular weight hyperbranched polyamides and the second group of hyperbranched polyamides form the low molecular weight hyperbranched polyamides. The combination of high molecular weight hyperbranched polyamides and low molecular weight hyperbranched polyamides improves the performance of the glue, in terms of both reactivity and technical characteristics. By way of example, said high molecular weight hyperbranched polyamides have an average molecular weight of at least 5000 g/mol and preferably at least 10 000 g/mol, for example an average molecular weight of between 5000 and 50 000 g/mol, preferably of between 10 000 and 25 000 g/mol. The low molecular weight polyamides then have, for example, an average molecular weight of between 500 and 5000 g/mol. With the aid of this combination, the further polymerization of the glue during the pressing of the board is accelerated. The pumpability of the glue is also better. The glue is also better able to wet the cellulose-containing material, as a result of which the distribution of the glue on the cellulose-containing material is better and the treatment with glue proceeds better. Groups of hyperbranched polyamides having an average molecular weight are discussed here. Not all macromolecules from the same group have the same molecular weight. This is for example due to the production of these hyperbranched polyamides. In the polycondensation of amino acids, not all amino acids will achieve the same reactions, that is to say obtain the same branches, as a result of which the hyperbranched polyamides obtained have different molecular weights. The hyperbranched polyamides from one and the same group are obtained, for example, by the same production process, wherein for example the polycondensation takes place for a longer period of time for the first group of hyperbranched polyamides than for the second group of hyperbranched polyamides so that the average molecular weight of the first group of hyperbranched polyamides is higher than the average molecular weight of the second group of hyperbranched polyamides. The molecular weight of hyperbranched polyamides may be determined, for example, by low-angle laser light scattering (LALLS). As an alternative or in addition, the molecular weight may be determined by gel permeation chromatography (GPC).

The second group of hyperbranched polyamides further preferably constitutes between 5 and 30 percent by weight of the total weight of the hyperbranched polyamides, preferably between 10 and 20 percent by weight.

In a preferred embodiment, the glue comprises crosslinkers, wherein these crosslinkers are preferably selected from the group comprising polyketones, polyesters, isocyanate dispersions, epoxides, glyoxal and other dialdehydes.

By way of example, said crosslinkers are or comprise polyesters, these polyesters preferably being dispersed and/or unsaturated polyesters. These unsaturated polyesters are, for example, hyperbranched, as a result of which they can be readily dissolved and do not adversely affect the viscosity of the glue used for forming the boards. During the production of the boards, which involves the use of pressing, the acidity of the polyesters is preferably brought towards the acidity of the polyamides or stabilized so that no acid-base reactions, thus pre-polymerization, takes place prior to the pressing.

The glue may comprise one or more types of crosslinkers. During the pressing of the boards, these crosslinkers ensure better and more rapid adhesion between the cellulose-containing materials, with the result that the board obtained has the required stability and strength and the connection between the cellulose-containing materials does not break undesirably. In addition, with the aid of these crosslinkers, the pressing time may be further shortened and the technical characteristics of the end product, such as the chipboard, OSB or MDF, increase. The technical characteristics are, for example, the flexural strength, tensile strength, compressive strength and water resistance.

By way of example, said crosslinkers are or comprise epoxides. Excellent results are achieved with the aid of epoxides, such as diepoxides or triepoxides or polyepoxides or a combination of various aforementioned epoxides. These epoxides, for example the diepoxides or the triepoxides, may for example comprise one or more oxirane end groups and preferably comprise two or more oxirane end groups. These epoxides may for example be created via bio-based routes from lignin or aniline, such as glycerol diglycidyl ether, and/or ethylene glycol diglycidyl ether. These epoxides may for example comprise diglycidyl ether of vanillyl alcohol and/or phloroglucinol tris epoxy. It is known that epoxides react with amines. However, it is exceptional here that, in the case of hyperbranched polyamides, epoxides can be added without pre-polymerization when the cellulose-containing material is being treated with glue, prior to the pressing of the board. It is only when pressure and temperature are added in the press that the epoxide becomes active. This does not impede the pressing of the board and makes it possible to establish the bond between the cellulose-containing materials in a highly satisfactory manner. These crosslinkers may have already been mixed with the hyperbranched polyamide components of the used glue in advance and stored thus. However, the crosslinkers may also be combined with the hyperbranched polyamide components of the used glue shortly before the treatment with glue. The glue used is then, for example, of two-component form, comprising a first component comprising the hyperbranched polyamides and a second component comprising crosslinkers, wherein these two components are combined only prior to the treatment with glue or during the treatment with glue of the cellulose-containing materials. Said crosslinkers may also be considered separate ingredients, independently of the glue used, in the production of boards, wherein the glue used then forms, together with the crosslinkers, the glue based on hyperbranched polyamides that is present in the board.

The weight ratio of crosslinkers to hyperbranched polyamides is further preferably between 0.02 and 0.15. It is thus for example possible for there to be between 3 and 6 percent by weight of epoxides in relation to hyperbranched polyamides. A higher proportion of crosslinkers contributes to the water resistance of the glue and thus of the board comprising this glue. The content of the crosslinkers must also not be too high, as this may lead to pre-polymerization of the glue, prior to the pressing of the board. This weight ratio ensures optimal technical characteristics, more particularly a better tensile strength, flexural strength and compressive strength and a better water resistance. Such boards are therefore not only suitable for applications in dry indoor environments (service class 1) but are also very suitable in more moist spaces, such as interior spaces such as bathrooms (service class 2).

The present invention also relates to a method for forming boards comprising cellulose-containing materials, such as plant fibres and/or wood chips and/or wood parts, wherein cellulose-containing materials are provided and a glue is applied to these cellulose-containing materials, after which these cellulose-containing materials provided with glue are pressed to form a board-like material in order to thus form boards, wherein the glue is a glue based on hyperbranched polyamides. With the aid of this method, a board as described above is obtained. All the advantages, embodiments and information described above therefore apply to this method. Surprisingly, the pressing to form boards here may proceed similarly to the pressing of cellulose-containing materials provided with glue to form boards, in which the glue is a conventional UF glue.

The cellulose-containing materials, such as wood chips, wood shavings, wood layers, wood fibres or other plant fibres, are provided with glue, thus treated with glue, by for example spraying/pouring glue onto these cellulose-containing materials. To this end, the cellulose-containing materials may be located on a vibrating conveyor belt or in a mixing vessel in order for the cellulose-containing materials to be treated with glue in as homogeneous a manner as possible. Then, the glue-treated cellulose-containing materials are pressed together in, for example, a continuous press or a discontinuous press, under a certain pressure, for example a pressure of between 2 and 6 N/mm², preferably of between 2 and 4 N/mm², at a certain temperature, for example a temperature of between 160° C. and 245° C., preferably 200° C. and 245° C., and for a certain period of time, for example at least four seconds per mm of board thickness. Here, the glue will bind with the cellulose-containing materials so as to obtain a solid board. This glue may be of one-component form, in which case the glue is stored in its entirety and is applied in its entirety to the cellulose-containing materials. The glue may also be of two-component or multi-component form, in which case the glue comprises two or more different components which are stored separately, wherein these components are combined prior to the treatment with glue and are thus applied as a single entity to the cellulose-containing materials or wherein these components are applied without prior combination to the cellulose-containing materials, and this application may or may not be simultaneous.

Said hyperbranched polyamides of the glue are preferably obtained by polycondensation of amino acids, wherein these amino acids are preferably selected from the group comprising arginine, glutamine, asparagine and lysine.

In a preferred embodiment, the hyperbranched polyamides comprise a first group of hyperbranched polyamides having an average molecular weight of between 500 and 100 000 g/mol, preferably of between 5000 and 50 000 g/mol and even more preferably of between 10 000 and 25 000 g/mol, and wherein the hyperbranched polyamides preferably comprise a second group of hyperbranched polyamides, wherein the average molecular weight of the first group of hyperbranched polyamides is at least three times higher, preferably at least five times higher, than the average molecular weight of the second group of hyperbranched polyamides and/or wherein the average molecular weight of the first group of hyperbranched polyamides is at most 15 times higher, preferably at most 10 times higher, than the average molecular weight of the second group of hyperbranched polyamides, and wherein the second group of hyperbranched polyamides further preferably constitutes between 5 and 30 percent by weight of the total weight of the hyperbranched polyamides, preferably between 10 and 20 percent by weight.

In a specific embodiment, the board comprises one or more layers, wherein these layers are pressed together if there are multiple layers, and wherein at least one aforementioned layer comprises said cellulose-containing materials and said glue, wherein the weight ratio of hyperbranched polyamides to cellulose-containing materials in this layer is preferably between 0.03 and 0.15, and wherein, in a specific embodiment, the board consists of three or more layers comprising outer layers and one or more central layers, wherein at least one central layer comprises said cellulose-containing materials and said glue, and wherein the outer layers each comprise cellulose-containing materials and a glue based on hyperbranched polyamides, wherein the weight ratio of hyperbranched polyamides to cellulose-containing materials in the outer layers is higher than the weight ratio of hyperbranched polyamides to cellulose-containing materials in the last-mentioned central layer. The glues in said outer layers and central layer may all be the same or they may also be different, but still based on hyperbranched polyamides.

In a specific embodiment, the glue comprises crosslinkers and/or crosslinkers are applied to the cellulose-containing materials, wherein these crosslinkers are preferably selected from the group comprising polyketones, polyesters, isocyanate dispersions, epoxides, glyoxal and other dialdehydes and wherein the weight ratio of crosslinkers to hyperbranched polyamides is also preferably between 0.02 and 0.15. If the glue itself does not comprise the crosslinkers, crosslinkers may be applied to the cellulose-containing materials after the treatment with glue or during the treatment with glue. It is possible for the crosslinkers to be mixed with the glue prior to the treatment with glue of the cellulose-containing materials. Preferably, the pressing takes place after the crosslinkers have been applied to the cellulose-containing materials. With the aid of crosslinkers, the polymerization during the pressing is accelerated and the cellulose-containing materials are thus connected to each other more rapidly. In this way, the pressing time may be lower than 10 seconds per mm of board thickness. These crosslinkers may or may not form part of the glue. The glue may thus be a one-component glue, in which case all the components of the glue have already been added together and the glue is stored thus. The glue may also be a two-component or multi-component glue, in which case the glue comprises two or multiple components which are combined with each other prior to the treatment with glue or which are applied together or successively to the cellulose-containing materials. The glue may thus comprise a component comprising the crosslinkers and a component comprising the hyperbranched polyamides. In this way, the crosslinkers are prevented from already reacting with the hyperbranched polyamides prior to the pressing of the board. The crosslinkers may also be considered separate components that do not form part of the glue. By way of example, the crosslinkers are or comprise polyesters, these polyesters preferably being dispersed and/or unsaturated polyesters. By way of example, the crosslinkers are or comprise epoxides. These epoxides may for example be created via bio-based routes from lignin or aniline, such as glycerol diglycidyl ether, and/or ethylene glycol diglycidyl ether.

The glue used is further preferably of at least two-component form comprising a first component comprising said hyperbranched polyamides and a second component comprising said crosslinkers, wherein, prior to the treatment with glue of the cellulose-containing materials, said components are first combined with each other and then the glue is applied to the cellulose-containing materials. Here, the crosslinkers are distributed well with respect to the hyperbranched polyamides, as a result of which the glue can perform its function in a satisfactory manner over the entire board.

In a very preferred embodiment, the glue comprises water as solvent and the glue thus forms an aqueous solution which, preferably, comprises between 50 and 70 percent by weight of hyperbranched polyamides. If the glue is of two-component or multi-component form, this aqueous solution forms, for example, the above-mentioned first component of the glue or this aqueous solution is obtained by combining the components of the glue. During the treatment with glue of the cellulose-containing materials, the water ensures that the cellulose-containing materials become wet and there is even slight penetration of the cell wall. With the aid of this glue, the cellulose-containing materials can be connected to each other in a highly satisfactory manner due to the good contact between the glue and the cellulose-containing materials. With the aid of water as solvent, contact between the glue and the cellulose-containing materials over virtually the entire outer surface of the cellulose-containing materials is possible.

The glue also preferably has a viscosity of at most 20 000 mPa·s, preferably at most 2000 mPa·s, at 20° C. and 1.013 bar. If the glue is of two-component or multi-component form, the foregoing relates, for example, to the above-mentioned first component of the glue, or to the glue after the components have been combined. This low viscosity ensures that the glue makes good contact with the cellulose-containing materials and also ensures good pressability of the glue-treated cellulose-containing materials. This low viscosity may, for example, be achieved with the aid of water, this water serving as solvent for the hyperbranched polyamides.

In a preferred embodiment, the pressing is effected at a temperature of between 150° C. and 250° C., with a pressing pressure of between 1.5 and 5 N/mm², for at least three seconds per mm of board thickness. The pressing time may be, for example, 5 to 7 seconds per mm of board thickness. These are ideal conditions for producing three-layer chipboards. Use may be made of a continuous press or a discontinuous press. Preferably, surfaces are sprayed at the bottom and at the top with water, for example between 10 and 50 g/m² of water, in order thus to promote the transfer of heat towards the middle of the board and to reduce the total pressing time.

In a specific embodiment, the cellulose-containing material is coated with glue by atomization, by friction between the wood particles or a combination of both techniques. The cellulose-containing material is thus treated with glue in a satisfactory manner. This relates to a similar or the same level of glue treatment as is implemented when using current UF glues, as a result of which an existing glue-treatment step of an existing production process does not have to be adapted, or only to a limited extent, to the glue according to the invention.

The present invention also relates to glue for connecting cellulose-containing materials, such as plant fibres and/or wood chips and/or wood parts, to form boards, wherein the glue is based on hyperbranched polyamides. This glue is the glue used to manufacture boards according to the method as described above. The advantages, embodiments and information relating to the board as presented and described above in the case of the method according to the invention therefore apply to this glue. Surprisingly, it has been found that such a glue is very suitable for gluing cellulose-containing materials, such as wood fibres or other plant fibres, wood chips, wood layers and wood shavings, to each other for the purpose of forming boards by pressing.

The hyperbranched polyamides are preferably obtained by polycondensation of amino acids, wherein these amino acids are preferably selected from the group comprising arginine, glutamine, asparagine and lysine.

In a preferred embodiment, the hyperbranched polyamides comprise a first group of hyperbranched polyamides having an average molecular weight of between 500 and 100 000 g/mol, preferably of between 5000 and 50 000 g/mol and even more preferably of between 10 000 and 25 000 g/mol, and wherein the hyperbranched polyamides preferably comprise a second group of hyperbranched polyamides, wherein the average molecular weight of the first group of hyperbranched polyamides is at least three times higher, preferably at least five times higher, than the average molecular weight of the second group of hyperbranched polyamides and/or wherein the average molecular weight of the first group of hyperbranched polyamides is at most 15 times higher, preferably at most 10 times higher, than the average molecular weight of the second group of hyperbranched polyamides, and wherein the second group of hyperbranched polyamides further preferably constitutes between 5 and 30 percent by weight of the total weight of the hyperbranched polyamides, preferably between 10 and 20 percent by weight.

In a specific embodiment, the glue comprises crosslinkers, wherein these crosslinkers are preferably selected from the group comprising polyketones, polyesters, isocyanate dispersions, epoxides, glyoxal and other dialdehydes and wherein the weight ratio of crosslinkers to hyperbranched polyamides is also preferably between 0.02 and 0.15. The glue may be a one-component glue, all the components of which have already been mixed in advance and thus are stored as a single entity. The glue may also be of at least two-component form, in which case the glue comprises a first component comprising the hyperbranched polyamides and a second component comprising the crosslinkers, and wherein the different components are mixed with each other for example prior to the treatment with glue. By way of example, the crosslinkers are or comprise polyesters, these polyesters preferably being dispersed and/or unsaturated polyesters. By way of example, the crosslinkers are or comprise epoxides. Excellent results are achieved with the aid of epoxides, such as diepoxides. These epoxides may for example be created via bio-based routes from lignin or aniline, such as glycerol diglycidyl ether, and/or ethylene glycol diglycidyl ether.

In a preferred embodiment, the glue comprises water as solvent and thus forms an aqueous solution which, preferably, comprises 50 to 70 percent by weight of hyperbranched polyamides. If the glue is of two-component or multi-component form, this aqueous solution forms, for example, the above-mentioned first component of the glue or this aqueous solution is formed by combining said components.

The glue preferably has a viscosity of at most 20 000 mPa·s, preferably at most 2000 mPa·s, at 20° C. and 1.013 bar. If the glue is of two-component or multi-component form, the foregoing relates, for example, to the above-mentioned first component of the glue, or relates to the glue obtained by combining said components.

An alternative embodiment of the invention relates to a glue for connecting insulation materials, such as glass wool, rock wool, etc., to form, for example, mats, wherein the glue is a glue based on hyperbranched polyamides. The preferred embodiments of the glue as presented above also apply to this alternative embodiment. With the aid of this glue, insulation material, such as glass wool, rock wool, etc., is then formed. The invention then also relates to an insulation material, such as glass wool or rock wool, comprising a glue based on hyperbranched polyamides and also to a method for manufacturing insulation material, such as glass wool or rock wool, wherein a glue based on hyperbranched polyamides is provided.

According to a divergent variant, the invention relates to a method for producing a base raw material comprising amino acids, wherein this base raw material can be used to produce hyperbranched polyamides, preferably by polycondensation of the amino acids of the base raw material. The base raw material is preferably obtained by fermentation, this fermentation preferably being carried out by bacteria. This base raw material is then used to form hyperbranched polyamides, for example by allowing polycondensation of the amino acids present to take place at a certain temperature, for example of between 120° C. and 180° C., for a number of hours and, for example, in the presence of any catalysts and/or a strong base, such as KOH. Specific embodiments of the divergent variant are presented in the non-exhaustive list below. Combinations of features from this non-exhaustive list are possible insofar as these are not in contradiction to each other:
Bacteria are provided which are able to produce amino acids in a targeted manner by fermentation. It is for example possible to provide bacteria which are able to produce predominantly lysine, and for example in smaller quantities one or more other amino acids such as glutamine, wherein the percentage of other amino acids preferably constitutes at most 20%, preferably at most 10%, of the total amount of amino acids produced. Here, these bacteria then produce a base raw material comprising amino acids, wherein this base raw material can be considered a lysine source of industrial quality. The standards for a lysine source of industrial quality are lower than those of a lysine source for food or feed purposes;
The base raw material comprises amino acids from the group comprising arginine, glutamine, asparagine and lysine. The base raw material may comprise one, a combination of two, a combination of three, or all the amino acids from the above-mentioned group;
The base raw material comprising amino acids is produced by fermentation by bacteria, wherein, for the fermentation, one or more carbohydrate sources are provided and one or more nitrogen sources, such as ammonium sources, are provided. The nitrogen sources may be, for example, residual products comprising one or more types of amino acids. The one or more ammonium sources comprise, for example, one or more ammonium salts, such as ammonium sulfate or (di)ammonium phosphate or ammonium acetate. The one or more carbohydrate sources comprise, for example, sucrose, glucose, cellulose, hemicellulose, lignocellulose, starch or lignin. The carbohydrate sources are, for example, molasses, such as blackstrap molasses or sugar beet molasses, starch, glucose, sucrose, fructose, starch hydrolysates, wastewater comprising starch, such as wastewater from potato processing companies/vegetable processing companies, wood-comprising sources, recycled sources such as recycled MDF or recycled chipboards, sugar beet syrup, corn steep liquor. The one or more nitrogen sources comprise, for example, complex nitrogen sources such as corn steep liquor, yeast extract, tryptone, peptone, soybean cake hydrolysate (residual product from the extraction of oil from soybeans), casein hydrolysate, or other nitrogen sources such as urea, ammonium phosphate, ammonium sulfate. Corn steep liquor is for example obtained by treating maize with SO₂. It is for example possible to only use ammonium phosphate and/or ammonium sulfate as nitrogen source, wherein then preferably more ammonium sulfate than ammonium phosphate is used. Ammonium sulfate may be, for example, a secondary product that occurs during bio-fermentation for the production of biogas. It is also possible to only use complex nitrogen sources as nitrogen source. It is also possible to use complex nitrogen sources and other nitrogen sources. The result of the fermentation is, for example, a base raw material in the form of a slurry, this slurry comprising amino acids. A drying step of this slurry is not necessary. The production of hyperbranched polyamides can be started without a preceding drying step of the slurry or with a limited drying step;
The result of the above-mentioned fermentation may be, for example, a base raw material in the form of a slurry, this slurry comprising amino acids. As indicated above, a drying step of this slurry is not necessary or operation can be performed with a limited drying step, in which case the slurry is not completely dried and there is still free water available after the drying step. This entails certain advantages. Less energy is required, since drying requires energy. It is also not necessary to use any harmful substances, such as chlorine. It is of course also possible for the slurry to be almost completely dried out and for there to thus be less than 5 percent by weight, preferably less than 3 percent by weight, of free water available, and this is done for example with the aid of spray drying.
For the production of the base raw material comprising amino acids, which is produced by fermentation by bacteria, provision is preferably also made of salts and/or trace elements in addition to the one or more carbohydrate sources and the one or more nitrogen sources. These trace elements may include one or more from the following list: potassium, magnesium, sodium, iron and manganese. The salts may be chlorides, for example salts of hydrochloric acid.
The base raw material comprising amino acids is produced by fermentation by bacteria. These bacteria may be, for example, Corynebacterium and/or E. coli bacteria, more specifically C. glutamicum strains which are preferably genetically modified to increase the productivity;
The base raw material is produced with the aid of bacterial strains that produce L-lysine. These bacterial strains may be, for example, Corynebacterium and/or E. coli bacteria;
The fermentation takes place at a pH of between 7 and 8, preferably between 7.3 and 7.7, and/or at a temperature of between 28° C. and 35° C., preferably of between 30° C. and 33° C.;
The fermentation takes place in a reactor with stirring mechanism ‘stirred tank reactor’
The fermentation takes place in batch, fed batch mode or continuous;
Additives, such as the above-mentioned trace elements, are added in order to increase the yield of a certain amino acid, such as L-lysine, during the fermentation.

With a view to providing a better illustration of the characteristic features of the invention, the following text describes a number of preferred embodiments by way of example, without any limiting character.

A first example of a panel according to the invention is a three-layer chipboard comprising two outer layers and a central layer. The central layer comprises coarse wood chips which may or may not originate from wood waste and/or recycled chipboards, and the outer layers comprise finer wood chips. Here, the wood chips are connected to each other with the aid of a glue based on hyperbranched polyamides.

A second example of a panel according to the invention is a wood fibreboard, such as an MDF or HDF board. This wood fibreboard is of one-layer form and comprises wood fibres and a glue based on hyperbranched polyamides.

These glues have the following properties:
the hyperbranched polyamides are obtained by polycondensation of amino acids which comprise predominantly lysine. In addition to lysine, which is preferably L-lysine, there is, for example, a small amount of glutamine. Glutamine thus constitutes, for example, at most 5 percent by weight of the amino acids present. Said amino acids originate from a base raw material comprising amino acids. This base raw material is, for example, obtained by the fermentation of bacteria, these bacteria forming lysine in a targeted manner;
the hyperbranched polyamides comprise a first group of hyperbranched polyamides which constitute between 80 and 90 percent by weight of the hyperbranched polyamides and a second group of hyperbranched polyamides which constitute the remaining percentage by weight of the hyperbranched polyamides. The first group of hyperbranched polyamides have an average molecular weight of between 10 000 and 25 000 g/mol and the second group of hyperbranched polyamides have an average molecular weight which is between 5 and 10 times lower than the average molecular weight of the first group of hyperbranched polyamides;
the glue comprises crosslinkers, such as epoxides, wherein the weight ratio of crosslinkers to hyperbranched polyamides is between 0.02 and 0.15.

In the case of the three-layer chipboard, the glue in the different layers is the same glue, and furthermore the weight ratio of hyperbranched polyamides to cellulose-containing materials in the central layer is between 4 and 5 percent by weight, and the weight ratio of hyperbranched polyamides to cellulose-containing materials in the outer layers is between 7.5 and 8.5 percent by weight. Thus, in this case, more glue is used for the outer layers than for the central layer. This provides confidence of the fact that the cellulose-containing materials in the outer layers will not detach from each other undesirably. The use of more glue in the outer layers is not redundant, since outer layers consist of finer particles, as a result of which the total surface area to be treated with glue increases significantly.

This chipboard may also be formed as follows. The wood chips are treated with glue in a drum-type glue-treatment machine with high-speed rotor, wherein the glue is added in non-atomized form. The glue used is, for example, a two-component glue comprising a first component comprising the hyperbranched polyamides and a second component comprising the crosslinkers. These two components are mixed prior to the treatment with glue, with the result that the glue comprises said crosslinkers and said hyperbranched polyamides. This glue is an aqueous solution comprising 50 to 70 percent by weight of hyperbranched polyamides. This glue has a viscosity of at most 2000 mPa·s at 20° C. and 1.013 bar. After the treatment with glue, the glue-treated wood chips are pressed together at 200° C. and a pressure of 4 N/mm² during the beginning phase, reducing to 2 N/mm², for between 5 and 9 seconds/mm of board thickness. This pressing is effected with the aid of a continuous press for the purpose of forming board-like material. This board-like material is sawn into boards having the desired dimensions.

1.-23. (canceled).

24. A board comprising cellulose-containing materials, such as plant fibres and/or wood chips and/or wood parts, and a glue which connects these cellulose-containing materials to each other,
wherein the glue is a glue based on hyperbranched polyamides.

25. The board according to claim 24, wherein said hyperbranched polyamides are obtained by polycondensation of amino acids.

26. The board according to claim 24, wherein the hyperbranched polyamides comprise a first group of hyperbranched polyamides having an average molecular weight of between 500 and 100 000 g/mol.

27. The board according to claim 24, wherein the board comprises one or more layers,
wherein at least one aforementioned layer comprises said cellulose-containing materials and said glue,
wherein the weight ratio of hyperbranched polyamides to cellulose-containing materials in this layer is between 0.03 and 0.15.

28. The board according to claim 27, wherein the board comprises three or more layers, namely two outer layers and one or more central layers,
wherein at least one central layer comprises said cellulose-containing materials and said glue, and
wherein the outer layers each comprise cellulose-containing materials and a glue based on hyperbranched polyamides,
wherein the weight ratio of hyperbranched polyamides to cellulose-containing materials in the outer layers is higher than the weight ratio of hyperbranched polyamides to cellulose-containing materials in the last-mentioned central layer.

29. The board according to claim 24, wherein the hyperbranched polyamides comprise a first group of hyperbranched polyamides and a second group of hyperbranched polyamides,
wherein the average molecular weight of the first group of hyperbranched polyamides is at least three times higher than the average molecular weight of the second group of hyperbranched polyamides and/or
wherein the average molecular weight of the first group of hyperbranched polyamides is at most 15 times higher than the average molecular weight of the second group of hyperbranched polyamides.

30. The board according to claim 29, wherein the second group of hyperbranched polyamides constitutes between 5 and 30 percent by weight of the total weight of the hyperbranched polyamides.

31. The board according to claim 24, wherein the glue comprises crosslinkers, wherein these crosslinkers are selected from the group comprising polyketones, polyesters, isocyanate dispersions, epoxides, glyoxal and other dialdehydes.

32. The board according to claim 31, wherein the weight ratio of crosslinkers to hyperbranched polyamides is between 0.02 and 0.15.

33. A method for forming boards comprising cellulose-containing materials, such as plant fibres and/or wood chips and/or wood parts,
wherein cellulose-containing materials are provided and a glue is applied to these cellulose-containing materials, after which these cellulose-containing materials provided with glue are pressed to form a board-like material in order to thus form boards,
wherein the glue is a glue based on hyperbranched polyamides.

34. The method according to claim 33, wherein said hyperbranched polyamides of the glue are obtained by polycondensation of amino acids.

35. The method according to claim 33, wherein the hyperbranched polyamides comprise a first group of hyperbranched polyamides having an average molecular weight of between 500 and 100 000 g/mol, and
wherein the hyperbranched polyamides comprise a second group of hyperbranched polyamides,
wherein the average molecular weight of the first group of hyperbranched polyamides is at least three times higher, than the average molecular weight of the second group of hyperbranched polyamides and/or wherein the average molecular weight of the first group of hyperbranched polyamides is at most 15 times higher than the average molecular weight of the second group of hyperbranched polyamides.

36. The method according to claim 33, wherein the board comprises one or more layers, wherein these layers are pressed together and wherein at least one aforementioned layer comprises said cellulose-containing materials and said glue,
wherein the weight ratio of hyperbranched polyamides to cellulose-containing materials in this layer is between 0.03 and 0.15.

37. The method according to claim 33, wherein the glue comprises crosslinkers and/or
wherein crosslinkers are applied to the cellulose-containing materials,
wherein these crosslinkers are selected from the group comprising polyketones, polyesters, isocyanate dispersions, epoxides, glyoxal and other dialdehydes.

38. The method according to claim 33, wherein the glue comprises water as solvent and thus forms an aqueous solution.

39. A glue for connecting cellulose-containing materials, such as plant fibres and/or wood chips and/or wood parts, to form boards,
wherein the glue is based on hyperbranched polyamides.

40. The glue according to claim 39, wherein the hyperbranched polyamides are obtained by polycondensation of amino acids,
wherein these amino acids are selected from the group comprising arginine, glutamine, asparagine and lysine.

41. The glue according to claim 39, wherein the hyperbranched polyamides comprise a first group of hyperbranched polyamides having an average molecular weight of between 500 and 100 000 g/mol, and
wherein the hyperbranched polyamides comprise a second group of hyperbranched polyamides,
wherein the average molecular weight of the first group of hyperbranched polyamides is at least three times higher, than the average molecular weight of the second group of hyperbranched polyamides and/or
wherein the average molecular weight of the first group of hyperbranched polyamides is at most 15 times higher, than the average molecular weight of the second group of hyperbranched polyamides.

42. The glue according to claim 39, wherein the glue comprises crosslinkers,
wherein these crosslinkers are selected from the group comprising polyketones, polyesters, isocyanate dispersions, epoxides, glyoxal and other dialdehydes and
wherein the weight ratio of crosslinkers to hyperbranched polyamides is between 0.02 and 0.15.

43. The glue according to claim 39, wherein the glue comprises water as solvent and thus forms an aqueous solution.
